(19) United States
(12) Patent Application Publication
(10) Pub. No.: US 2022/0096209 A1
(43) Pub. Date: Mar. 31, 2022

(54) CRYSTALLOGRAPHIC ORIENTATION STRUCTURED TITANIUM ALLOY DENTAL IMPLANT AND MANUFACTURING METHOD THEREOF

(71) Applicant: Cheng-Hsien Wu, Taichung City (TW)

(72) Inventors: CHENG-LI LO, Taichung City (TW); CHUNG-PING CHAO, Taichung City (TW); CHENG-HSIEN WU, Taichung City (TW)

(21) Appl. No.: 17/401,761

(22) Filed: Aug. 13, 2021

(30) Foreign Application Priority Data
Sep. 26, 2020 (TW) 109133521

(51) Int. Cl. A61C 8/00; C25D 11/26; C22C 14/00

(52) U.S. Cl. CPC A61C 8/0015; C22C 14/00; C25D 11/26

(57) ABSTRACT

The present invention provides a crystallographic orientation structured titanium alloy dental implant and manufacturing method thereof. The technique of modifying the surface structure (Ti/TiO₂, amorphous) of the titanium alloy dental implant to form a [Ti/TiO₂ anatase (215)] crystallographic orientation structure is applied in osseointegration field for improving activity of osteocyte, shortening the identification period of initial growth of osteocyte, accelerating the integration of human bone and the calcification of osteocyte tissue, with the advantage of healing wound fast, therefore being suitable for clinical treatment of dental implant surgery. The structure is relatively stable, uneasy to be worn and damage proof, not affected by the surface roughness, and assures the hydrophilicity of the adherence capacity of osteocyte. The structure features a specific crystal grains arrangement direction (crystallographic orientation) so as to increase cell activity, hydrophilicity, and biocompatibility.

### BACKGROUND OF THE INVENTION

### 1. Field of the Invention

The present invention relates to a crystallographic orientation structured titanium alloy dental implant and manufacturing method thereof, and more particularly, to a technique of modifying the surface structure (Ti/TiO₂, amorphous) of the titanium alloy dental implant to form a [Ti/TiO₂ anatase (215)] crystallographic orientation structure, so as to be applied in osseointegration field.

### 2. Description of the Related Art

Crystal structure of conventional metal materials has a lattice with regularly arranged atoms. Such crystal structure has multiple crystal planes composed of polycrystalline directions, and the crystal grains thereof are arranged in random orientation. However, when the metal material undergoes metal plastic processing methods such as rolling, extrusion, and drawing, and the deformation of metal crystal grains is arranged in a certain direction. The crystal grains distribution state of the pole figure can be obtained through the electron back scatter diffraction (EBSD) analysis. In addition, metal coating methods such as PVD and electrochemical plating can be applied for controlling the growth direction of crystal grains to form a monocrystalline orientation structure. The monocrystalline orientation structure has a certain direction of grains arrangement; however, the production is not easy. The present invention provides and discloses a crystallographic orientation structure, which applies the development technology of metal alloy electrolysis to control the electrolysis and oxidation mechanism. The electrolyzed metal will produce a crystal grain arrangement direction to promote oxidation for forming the crystallographic orientation structure, which involves the deposition of the oxide layer structure with a specific crystal grains arrangement direction (crystallographic orientation). Such direction is achieved by applying the technique of the diffraction direction of the HRXRD of the oxide layer structure to the osseointegration of titanium alloy dental implants. At present, no one has applied this method, which is novel and innovative. Commercially available brand of titanium alloy dental implants applies surface treatment technologies, such as sandblasting, sandblasted large-grit acid-etching (SLA), and anodic oxidation to form a porous structure and texture on the surface to increase the attachment ability of the bone cells, so as to achieve the osseointegration. However, such structure will be affected by the surface roughness, which further affect the hydrophilicity.

Regarding the current issue of osseointegration, when the conventional titanium metal is exposed to air, a layer of titanium dioxide with a thickness of approximately 2 to 10 nanometers is immediately formed on the surface thereof. Because this oxide layer is biologically inert, stable in thickness and corrosion resistant, and able to trigger chemical and biological reactions, it has great biocompatibility, and is therefore a key factor for successful osseointegration. According to literature reports, the natural titanium dioxide layer on the surface of titanium metal has good biocompatibility with bone cells; however, it has an amorphous structure, which makes a relatively longer recognition period for bone cells to attach and grow in the initial stage. Therefore, it is desirable to shorten the recognition period for the attachment and growing of bone cells, thereby allowing bone cells to form a strong intertwined structure in the initial and subsequent stages of growth. The surface structure (Ti/TiO₂) composition of commercially available brand of titanium alloy dental implants is an amorphous structure and does not have a specific crystal grains arrangement direction. As a result, the osseointegration has a longer identification period of the initial attachment and growth of bone cells and a non-obvious behavior of bone cells growth, so that the issue of osseointegration remains not resolved. The invention provides a crystallographic orientation structured titanium alloy dental implant and manufacturing method thereof, which modify the surface structure (Ti/TiO₂, amorphous) of a commercially available brand of titanium alloy dental implant to form a [Ti/TiO₂ anatase (215)] crystallographic orientation structure with specific crystal grains arrangement direction (crystallographic orientation). This technique is applied in the osseointegration field for improving the activity of bone cells, shortening the recognition period of initial growth of bone cells, and accelerating the integration of active human bones and the calcification of bone cell tissue. Such technique achieves an advantage of fast wound healing and is applicable to clinical treatment of dental implants. The structure is relatively stable, uneasy to be worn and damage proof, not affected by the surface roughness, and assures the hydrophilicity of the adherence capacity of osteocyte. The structure features a specific crystal grains arrangement direction (crystallographic orientation), so as to increase cell activity, hydrophilicity, and biocompatibility. Thus, the present invention is inventive.

### SUMMARY OF THE INVENTION

In view of the issues above, the surface treatment technology of commercially available brand of titanium alloy dental implant forms an amorphous surface structure (Ti/TiO₂), which is unable to solve the current issues of osseointegration, namely the structure being unstable, easily worn and damaged, affected by surface roughness, and affecting hydrophilicity.

The invention provides a crystallographic orientation structured titanium alloy dental implant and manufacturing method thereof, which modify the surface structure (Ti/TiO₂, amorphous) of titanium alloy dental implant to form a [Ti/TiO₂ anatase (215)] crystallographic orientation structure with specific crystal grains arrangement direction (crystallographic orientation). This technique is applied in the osseointegration field for improving the activity of bone cells, shortening the recognition period of initial growth of bone cells, and accelerating the integration of active human bones and the calcification of bone cell tissue. Such technique achieves an advantage of fast wound healing and is applicable to clinical treatment of dental implants. The structure is relatively stable, uneasy to be worn and damage proof, not affected by the surface roughness, assures the hydrophilicity of the adherence capacity of osteocyte, and features a specific crystal grains arrangement direction (crystallographic orientation), so as to increase cell activity, hydrophilicity, and biocompatibility. Thus, the present invention is inventive.

A crystallographic orientation structure improves the mechanical strength and abrasion corrosion resistance of titanium alloy dental implants, prevents the release of metal ions, and increases biocompatibility. It is a biomedical material.

The crystallographic orientation structured titanium alloy dental implant of the present invention has a crystallographic orientation structure composition of [Ti/TiO₂ anatase (215)], wherein the metal activity thereof is Ti>Al>V. Regarding the grain growth method, metal titanium ion and O₂ chemically react and deposit to form a biomedical ceramic oxide layer structure, as shown in FIG. 5. It is different from the amorphous surface structure (Ti/TiO₂) of the commercially available brand of titanium alloy dental implant surface treatment technology, so as to be novel and inventive over conventional arts.

As shown by the result of the crystallographic orientation structure of titanium alloy dental implants from the analysis by high-resolution X-ray diffraction (HRXRD), the crystallographic orientation structure composition thereof is [Ti/TiO₂ anatase (215)], with a specific crystal grains arrangement direction (crystallographic orientation). This direction is the HRXRD diffraction direction (215) diffraction surface of the TiO₂ anatase oxide layer structure, with the diffraction peak value of 20=75 degrees.

Based on the hydrophilicity test, [Ti/TiO₂ anatase (215)] crystallographic orientation structure sample has a lower contact angle, is more hydrophilic, related to the specific crystal grains arrangement direction (crystallographic orientation), and not affected by surface roughness. In contrast, the amorphous structure (Ti/TiO₂) sample of commercially available brand of implants has a higher contact angle, low hydrophilicity, and affected by the surface roughness.

In the test of cell viability (survival rate %) measurement, the sample is cultured with osteoblasts (MG63). The analysis results of light absorbance (cell viability) and cell survival rate (MTT assay) show that [Ti/TiO₂ anatase (215)] crystallographic orientation structure sample has the highest light absorbance value, which means higher cell viability and higher survival rate. The specific crystal grains arrangement direction (crystallographic orientation) is related to the light absorbance value (cell activity), and can accordingly improves cell viability.

The [Ti/TiO₂ anatase (215)] crystallographic orientation structure of titanium alloy dental implants is not affected by the surface roughness, and relies on the specific crystal grains arrangement direction (crystallographic orientation), which saves surface treatment process costs and increases industrial benefits, so as to be inventive.

The present invention has stable product target. The crystallographic orientation structure has the osseointegration characteristic of stable and identical crystallographic orientation. By introducing titanium alloy material into titanium alloy dental implant, the productivity of the present invention is achieved.

### BRIEF DESCRIPTION OF THE DRAWINGS

FIG. 1 is a schematic diagram of X-ray diffraction according to an embodiment of the present invention.

FIG. 2 is a schematic diagram of X-ray diffraction according to a comparative example of the present invention.

FIG. 3 is a schematic diagram of the cell survival rate analysis of MTT.

FIG. 4 is a perspective view of the crystallographic orientation structured titanium alloy dental implant in accordance with an embodiment of the present invention.

FIG. 5 is a cross-sectional view and partially enlarged view taken along line 5-5 of FIG. 4.

### DETAILED DESCRIPTION OF THE INVENTION

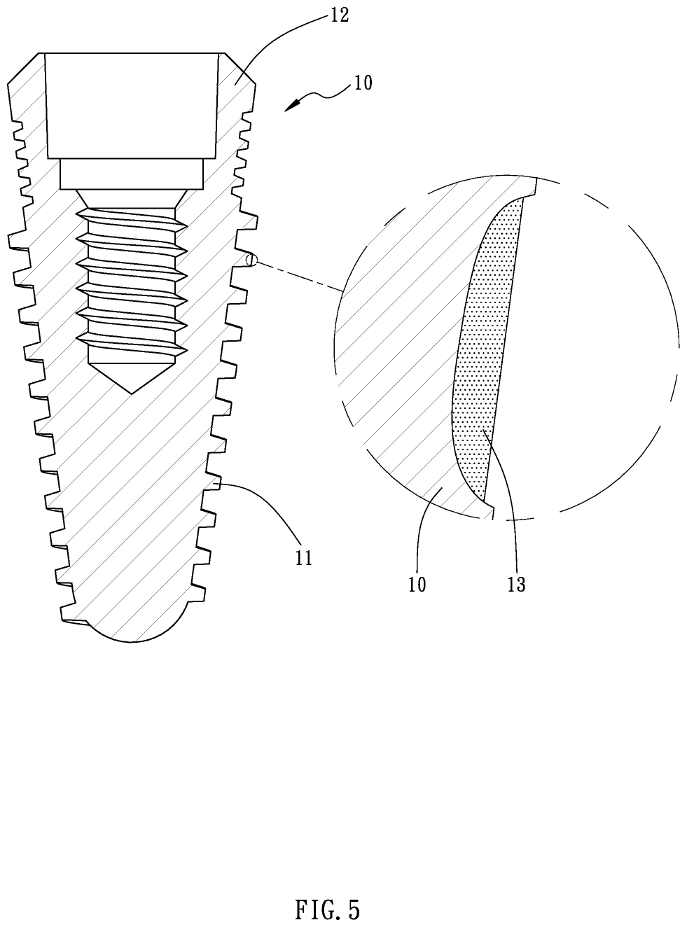

Referring to FIG. 5, the present invention provides a crystallographic orientation structured titanium alloy dental implant and manufacturing method thereof.

The manufacturing method is illustrated as follows.

(1) The chemical composition of the titanium alloy dental implant sample is Ti-6% Al-4% V.

(2) The titanium alloy dental implant sample is placed on the anode, and the electrolysis and oxidation mechanism are controlled, so that the electrolyzed titanium metal produces a crystal grains arrangement direction.

(3) Oxidation and formation of crystallographic orientation structure: Titanium metal produces crystal grains arrangement and promotes oxidation to form the crystallographic orientation structure, which includes the deposition of an oxide layer structure with a specific crystal grains arrangement direction (crystallographic orientation), wherein the direction is the HRXRD diffraction direction of the oxide layer structure.

(4) The crystallographic orientation structure composition accordingly manufactured is [Ti/TiO₂ anatase (215)], wherein the metal activity is Ti>Al>V.

The crystallographic orientation structure composition is represented as [Mx/MxO(hkl)]; the metal activity is Mx>My, wherein Mx and My are metal elements, and MxO is Mx metal oxide, and MxO(hkl) is the HRXRD diffraction direction thereof.

The formula and parameters of the electrolyte of titanium alloy electrolysis development technology are shown as follows:

Sulfuric acid (60%), 200 ml;

Glacial acetic acid, 1000 ml;

Controlling parameters: temperature between 20-25° C., voltage being 30V, current being 0.5-2 A, time between 60-180 sec.

The titanium alloy electrolysis development mechanism: electrolysis and oxidation mechanism are controlled.

The electrolysis is determined by the size of the titanium alloy composition: Ti (electrolyzed)>Al>V.

The oxidation is determined by the activity of the titanium alloy components: Ti (oxidized)>Al>V.

In the embodiment of the present invention, the crystallographic orientation structured titanium alloy dental implant and manufacturing method thereof use titanium alloy electrolysis development technology to control the electrolysis and oxidation mechanism to form the [Ti/TiO₂ anatase (215)] crystallographic orientation structure with specific crystal grains arrangement direction (crystallographic orientation). Such technique is applied in the osseointegration field for improving the activity of bone cells. The structure is relatively stable, uneasy to be worn and damage proof, not affected by the surface roughness, assures the hydrophilicity of the adherence capacity of osteocyte, and features a specific crystal grains arrangement direction (crystallographic orientation), so as to increase cell activity, hydrophilicity, and biocompatibility.

Following embodiments and comparative examples provide a person having ordinary skills in the field with a complete disclosure and description of articles, devices, and/or methods of making and evaluating the scope of the claims. Such contents are intended to be an illustration of the present invention and not intended to be used for limiting scope of the present invention.

### Embodiment

The titanium alloy electrolysis development technology is applied. To control the electrolysis and oxidation mechanism to form a crystallographic orientation structure [Ti/TiO₂ anatase (h,k,l)] sample, an electrolyte [200 ml of sulfuric acid (60%)+1000 ml of glacial acetic acid] with a 5 vol % water content is used. The titanium alloy sample is magnetically ground and pre-treated, including being cleansed, degreased with acetone organic solvent, acid pickled, and then electrolyzed with a 30V voltage, 0.5-2 A current for 60-180 seconds. During the electrolysis process, attention must be paid to the current conduction to prevent excessive electrolysis, failure of oxidation or excessive oxidation, and failure of electrolysis, which further cause failure of the grains arrangement of the electrolyzed titanium metal, resulting in poor metal grains arrangement, and generating electrolytic polishing mechanisms or anodic oxidation mechanism.

### Comparative Example

Regarding the surface structure (Ti/TiO₂, amorphous) of the commercially available brand of titanium alloy dental implant surface treatment technology, the sample uses anodic oxidation technology, which is a surface oxidation mechanism, and the electrolyte formula has 200 ml/L of sulfuric acid (60%), with the rest of the formula being water content. The sample is magnetically ground and pre-treated, including being cleansed, degreased with acetone organic solvent, acid pickled, and then anodic oxidized with a 30V voltage, 0.5-2 A current for 60-180 seconds.

Regarding the embodiment of the method of present invention and the comparative example, tests of HRXRD material analysis and the hydrophilicity and cell viability were carried out. The experimental results are discussed as follows.

1. High Resolution X-Ray Diffraction (HRXRD): Low Grazing Angle Diffraction Analysis

As shown by HRXRD diffraction analysis results, the crystallographic orientation structure composition is [Ti/TiO₂ anatase (h,k,l)] with a specific crystal grains arrangement direction (crystallographic orientation). The direction is the diffraction direction (hkl) of TiO₂ anatase oxide layer structure, with a peak value of 20.

### Embodiment

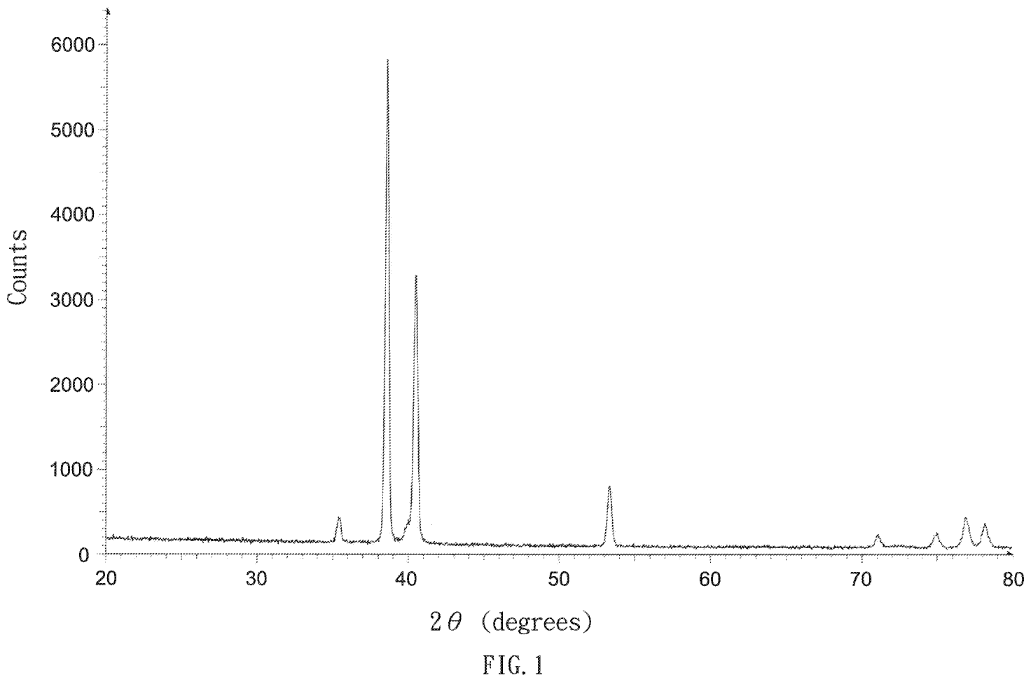

titanium alloy electrolysis development technology. The crystallographic orientation structure composition is [Ti/TiO₂ anatase (215)], with a specific crystal grains arrangement direction (crystallographic orientation), wherein the direction is the diffraction direction of the TiO₂ anatase oxide layer structure (215), with the diffraction peak of 20=75 degrees, as shown in FIG. 1.

### Comparative Example

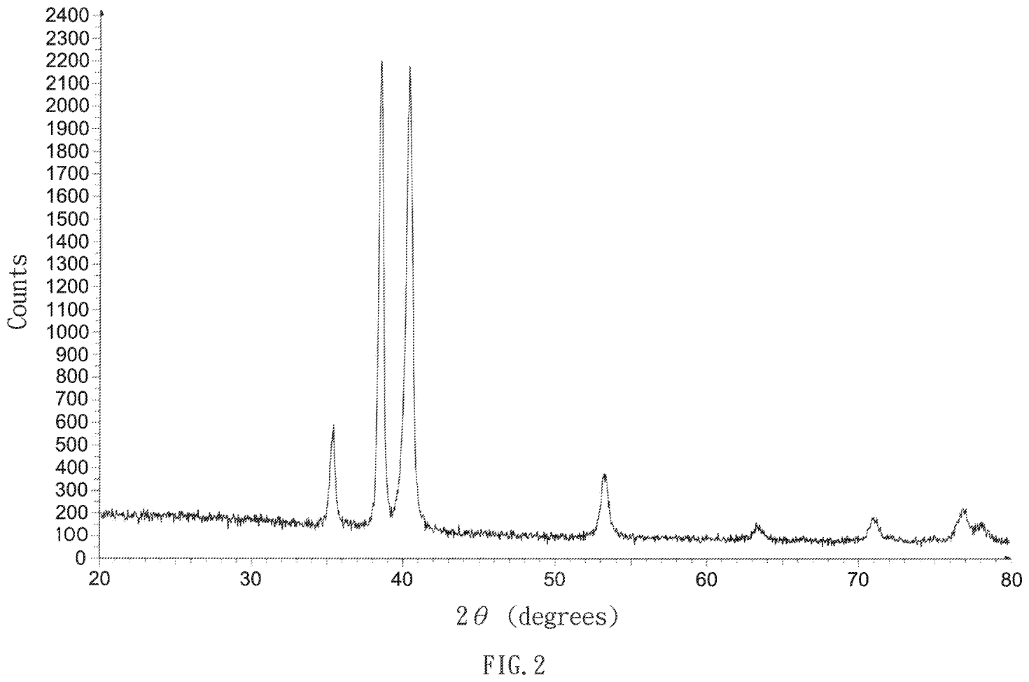

titanium alloy anodic technology. The structure is an amorphous (Ti/TiO₂) structure, wherein the crystal grains are loose, without specific crystal grains arrangement direction, showing no TiO₂ anatase diffraction direction and the peak value of 20, as shown in FIG. 2.

2. Hydrophilicity and Cell Viability Test:

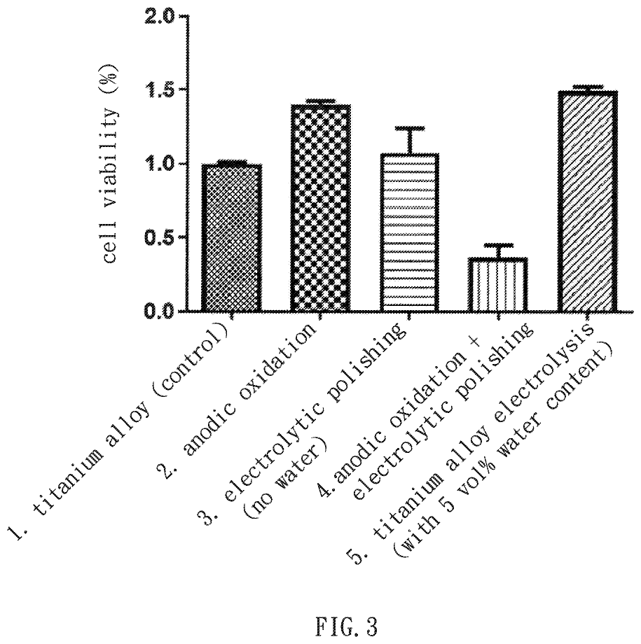

According to the results of the test data arranged from Table 1 and MTT cell survival rate analysis chart of FIG. 3, by comparing the [Ti/TiO₂ anatase (215)] crystallographic orientation structure sample manufactured by the present invention with the amorphous surface structure (Ti/TiO₂) sample of the commercially available brand of implant of the comparative example, the [Ti/TiO₂ anatase (215)] crystallographic orientation structure has the highest light absorbance value, which means a higher cell activity and higher survival rate, lower contact angle, and more hydrophilic, so that it can accelerate the integration of active human bones, thereby confirming that the hydrophilicity and cell activity are related to the specific crystal grains arrangement direction (crystallographic orientation), and facilitates the promotion of osseointegration.

Table 1 shows the hydrophilicity and cell viability test data. The test is carried out by industry-university cooperation of the Department of Dentistry, China Medical University.

TABLE 1

| | Comparative | |
|---|---|---|
| | Example | |
| | amorphous surface | |
| | structure (Ti/TiO₂) | Embodiment |
| | sample of the | [Ti/TiO₂ anatase |
| | commercially | (215)] |
| | available brand of | crystallographic |
| | implant | orientation structure |
| hydrophilicity | 68.93 degrees | 64.52 degrees |
| test average | | |
| contact angle | | |
| cell viability | 0.6565 | 0.709 |
| test light | | |
| absorbance | | |

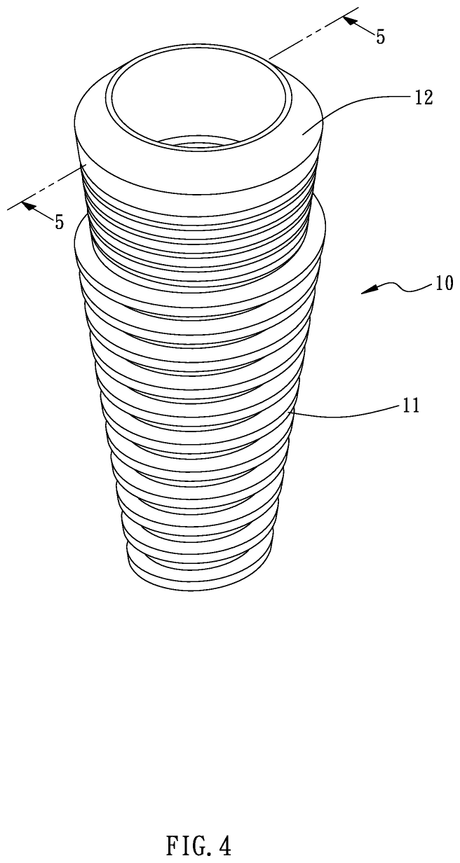

As shown by FIG. 4 and FIG. 5, the crystallographic orientation structured titanium alloy dental implant obtained by the aforementioned manufacturing method comprises a titanium alloy implant 10, with one end of the titanium alloy implant 10 having a thread portion 11, and the other end of the titanium alloy implant 10 having a fix portion 12; and a crystallographic orientation structure 13 formed on the titanium alloy implant through electrolysis and oxidation mechanisms. The crystallographic orientation structure 13 includes the deposition of an oxide layer structure with a specific crystal grains arrangement direction (crystallographic orientation), wherein the diffraction direction (215) measured through the HRXRD. Accordingly, the crystallographic orientation structured titanium alloy dental implant has the aforementioned effects.

The above-mentioned results of material analysis and experiments verify the embodiments of the present invention and comparative examples, thereby solving the above-mentioned problems. Therefore, the present invention is inventive.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A manufacturing method of a crystallographic orientation structured titanium alloy dental implant, comprising following steps:
(1) providing a titanium alloy dental implant sample having a chemical composition of Ti-6% Al-4% V;
(2) placing the titanium alloy dental implant sample on an anode, and controlling an electrolysis and oxidation mechanism, and electrolyzing the titanium metal to produce a crystal grains arrangement direction;
(3) oxidation and formation of a crystallographic orientation structure, the titanium metal producing a crystal grains arrangement, promoting the oxidation and formation of the crystallographic orientation structure, which includes a deposition of an oxide layer structure with a specific crystal grains arrangement direction (crystallographic orientation), wherein the direction is a HRXRD diffraction direction of the oxide layer structure; and
(4) producing the crystallographic orientation structure having a composition of [Ti/TiO₂ anatase (215)], wherein a metal activity is Ti>Al>V.

2. The manufacturing method of claim 1, wherein a grain growth method is that metal titanium ions and O₂ chemically react and deposit to form a biomedical ceramic oxide layer structure.

3. The manufacturing method of claim 1, wherein according to a result by high-resolution X-ray diffraction (HRXRD), the crystallographic orientation structure composition thereof is [Ti/TiO₂ anatase (215)], with the specific crystal grains arrangement direction (crystallographic orientation), and the direction is a HRXRD diffraction direction (215) diffraction surface of the TiO₂ anatase oxide layer structure, with a diffraction peak value of 20=75 degrees.

4. The manufacturing method of claim 1, wherein a titanium alloy electrolysis is applied; to control the electrolysis and oxidation mechanism to electrolyze the metal to produces the crystal grains arrangement direction, an electrolyte formulation with a 5 vol % water content is used.

5. The manufacturing method of claim 1, wherein a technology of the manufacturing method is applied to metal industry, aerospace industry, and medical materials industry.

6. A crystallographic orientation structured titanium alloy dental implant manufactured by the manufacturing method of claim 1, the crystallographic orientation structured titanium alloy implant comprising:
a titanium alloy implant; and
a crystallographic orientation structure, including an oxide layer deposition structure formed on the titanium alloy implant through the electrolysis and oxidation mechanism, and the specific crystal grains arrangement direction (crystallographic orientation).

7. The crystallographic orientation structured titanium alloy dental implant of claim 6, wherein the titanium alloy implant has a thread portion on one end, and a fix portion on the other end.
